(19) United States
(12) Patent Application Publication
(10) Pub. No.: US 2006/0261591 A1
(43) Pub. Date: Nov. 23, 2006

(54) Customizable board book and kit

(76) Inventors: James Hewitt, Loveland, OH (US); Julie Hewitt, Loveland, OH (US)

Correspondence Address: THOMPSON HINE L.L.P., P.O. BOX 8801, DAYTON, OH, 45401-8801, US

(21) Appl. No.: 11/133,552

(22) Filed: May 20, 2005

(51) Int. Cl. B42D 1/08

(52) U.S. Cl. 281/22

(57) ABSTRACT

A kit for enabling a child to produce a book format record including customized text and photographs of a particular event experienced by the child is provided. The kit includes a board book including a plurality of bound, substantially rigid pages and a plurality of picture pockets. Each picture pocket includes an affixing portion for enabling the picture pocket to be affixed to a page of the board book and a front portion adapted to permit picture viewing. The board book and the picture pockets are packaged together for purchase with at least some of the picture pockets unattached to the board book so that picture pockets can be attached to the pages at child selected locations after the kit is purchased.

### TECHNICAL FIELD

The present application relates to a customizable board book and a kit for use in making a customized board book.

### BACKGROUND

Photo albums are frequently used to collect and arrange photographs for viewing. Typically, a photo album includes numerous pages and acid-free protective sheets attached thereto along one edge. Photographs can be placed on a surface of a page of the photo album beneath the protective sheet. In some instances, a user may dedicate an entire photo album to a single event such that the photo album includes only photographs from that event. The photographs may be arranged in the album in some form of logical order, such as chronologically.

Typical photo albums may be ill suited for use by young children, for example, due to their size or level of interactivity. To this end, display books have been proposed having predetermined locations to which photographs can be applied. The display books include pictorial representations such as cartoon characters that include a photographic site to which a personalized photograph can be applied.

### SUMMARY

In an aspect, a kit for enabling a child to produce a book format record including customized text and photographs of a particular event experienced by the child is provided. The kit includes a board book including a plurality of bound, substantially rigid pages and a plurality of picture pockets. Each picture pocket includes an affixing portion for enabling the picture pocket to be affixed to a page of the board book and a front portion adapted to permit picture viewing. The board book and the picture pockets are packaged together for purchase with at least some of the picture pockets unattached to the board book so that picture pockets can be attached to the pages at child selected locations after the kit is purchased.

In another aspect, a method of making a kit for use in creating a book format record including customized text and photographs of a particular event experienced by a child is provided. The method includes providing a board book including a plurality of bound, substantially rigid pages. A plurality of picture pockets are also provided with each picture pocket including an affixing portion for enabling the picture pocket to be affixed to a page of the board book and a front portion adapted to permit picture viewing. The board book and the picture pockets are packaged together for purchase with at least some of the picture pockets unattached to the board book so that picture pockets can be attached to the pages at child selected locations after the kit is purchased.

In another aspect, a kit for enabling a child to produce a book format record including customized text and photographs of a particular event experienced by the child is provided. The kit includes a board book including a plurality of bound, substantially rigid pages disposed between a front cover and a back cover. The pages and the front cover and back cover are each in the form of a laminate where the front cover includes a title permanently applied to an outer surface of the front cover, the title tending to create a first theme. Adhesive-backed picture pockets carried by a backing sheet are provided. The backing sheet is configured to allow the picture pockets to be removed therefrom and to be affixed to a page of the board book. The picture pockets include a front portion adapted to permit picture viewing. A writing instrument is also provided for use in customizing the board book. The board book, the picture pockets and the writing instrument are packaged together for purchase with at least some of the picture pockets unattached to the board book so that picture pockets can be attached to the pages at child selected locations after the kit is purchased.

In another aspect, a method of creating a book format record including customized text and photographs of a particular event experienced by a child is provided. The method includes affixing picture pockets at child-selected locations to rigid pages of a board book. Photographs can be placed within the picture pockets for viewing. The pages can be written on so that a child can customize pages of the board book. In some instances, the board book and picture pockets are not packaged together for purchase (in some embodiments, the board book and picture pockets are purchased separately prior to affixing the picture pockets to pages of the board book). In some embodiments, openings of the picture pockets affixed to pages of the board book may be closed, for example, using adhesive-backed stickers.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is front view of an embodiment of a kit including customizable board book;

FIG. 2 is a front, perspective view of an embodiment of a board book packaged in the kit of FIG. 1;

FIG. 3 is a diagrammatic illustration of a page cantilevered at one end;

FIG. 4 is a section view of an embodiment of a page of the board book of FIG. 2;

FIGS. 5 and 6 illustrate a method of customizing a board book using the kit of FIG. 1;

FIG. 7 illustrates an inside surface of a front cover and sheet of the board book of FIG. 2;

FIG. 8 is a front, perspective view of a customized board book using the kit of FIG. 1;

FIG. 9 is a front view of an alternative binding for an embodiment of a board book; and

FIG. 10 is a front view of another embodiment of a board book.

### DETAILED DESCRIPTION

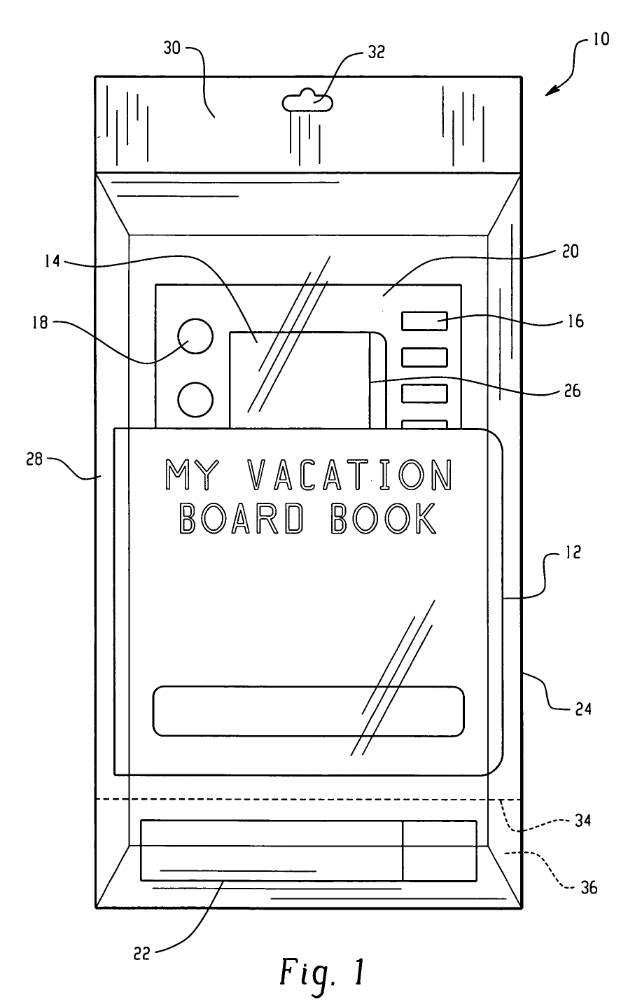

Referring to FIG. 1, a kit 10 includes a customizable board book 12 and various other items that can be used by a child to create a book format record of an event, such as a vacation, sporting event, educational activity such as a field trip or school lesson, family activity such as a reunion, holiday activity, birthday activity, etc. As will be described in greater detail below, the board book 12 is customizable by a child or adult, e.g., with the assistance of a child using other components included in the kit 10. As customized, the completed board book 12 with book format record can be made especially for handling and viewing by young children such as infants, toddlers and pre-school age children. The other items in the kit 10 can also be suitable for use and handling by a child.

In addition to board book 12, kit 10 includes adhesive-backed picture pockets 14, adhesive-backed graphics 16 and adhesive-backed closures 18. As shown, the picture pockets 14, graphics 16 and closures 18 are adhered to a common backing sheet 20 that can allow for their removal therefrom without damage to the adhesive backings. Alternatively, the picture pockets 14, graphics 16 and/or closures 18 may be adhered to separate backing sheets 20. In some embodiments, the backing sheet 20 may include separable portions (not shown) that are connected along a weakened boundary such as a perforated boundary to allow for separation between adjacent portions of the backing sheet. In some instances, the backing sheet 20 may be folded to facilitate insertion into a product package 24.

Graphics 16 can include a theme-related message and/or illustration and closures 18 can be used to close openings 26 of the picture pockets 14, for example, once a photograph has been inserted therein. In some embodiments, closures 18 are substantially circular stickers (e.g., having a ¾ inch diameter) and are formed of a transparent or semi-transparent material. A writing instrument 22 such as a marker, ink pen or crayon is provided for use in customizing the board book 12. In some instances, the kit 10 may not include one or more of the graphics 16, closures 18 and/or writing instrument 22. In some embodiments, the picture pockets 14 may not be adhesive-backed and may include other affixing means such as a fastener component including, for example, hooks and/or loops for releasably securing the picture pocket to a mating fastener component affixed to a sheet of the board book 12 or for use in closing openings 26.

Board book 12, picture pockets 14, graphics 16, closures 18 and writing instrument 22 are disposed in package 24. Package 24 includes a pouch 28, e.g., formed of a transparent plastic material that is connected to a header 30 having a hole 32 for use in hanging the kit 10 on a display for retail sale. In some embodiments, a seal (not shown), such as a reclosable seal is disposed between the header 30 and pouch contents. Components of the kit 10 may be packaged together to accommodate display in a retail store and/or components of the kit 10 may be packaged together for mailing, for example, directly to a purchaser who has purchased the kit 10 or to a retail store for customer purchase or any location in a distribution chain.

While FIG. 1 shows a pouch or bag 28, any suitable package can be used including a box, shrink-wrap, a blister package, a clamshell package, mail packaging, etc. Furthermore, the package may include compartments for use in separating selected items. For example, FIG. 1 shows an alternative pouch 28 that includes a seal 34 (shown by dotted lines) forming a compartment 36 in which only writing instrument 22 is located. In some embodiments, the bag 28 or other package is reusable and reclosable to allow items to be placed back into the package and to be secured therein. Kit 10 may include items in addition to those described above such as glitter, glue, fabrics, buttons, tape, yarn, string, ribbon, bows, etc. In cases where the kit 10 is theme oriented, items disposed in the kit may have characteristics associated with the pre-selected theme. Kit 10 may include multiple board books 12, for example, having differing or the same themes. In some embodiments, one or more of the board book 12, picture pockets 14, graphics 16, closures 18 and writing instrument 22 may be provided separate from the other components.

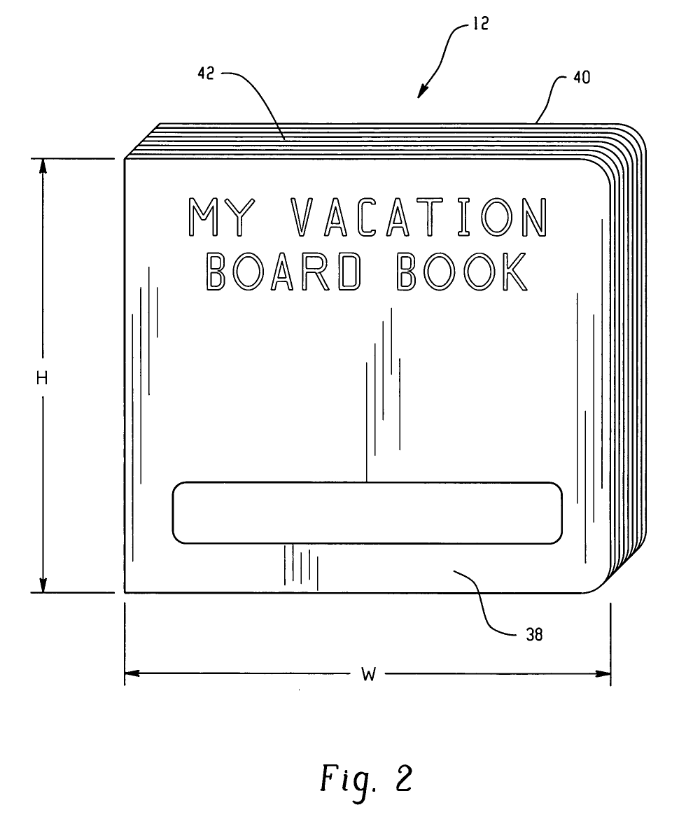

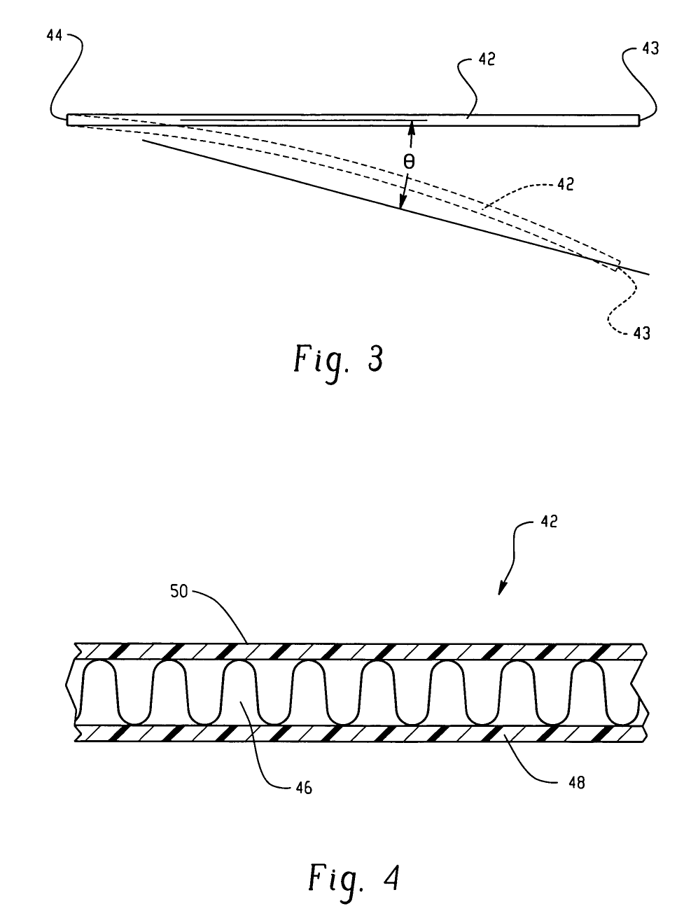

Referring to FIG. 2, board book 12 includes a front cover 38, a back cover 40 and multiple, bound pages 42 disposed therebetween. Each page 42 includes two sides. Pages 42, front cover 38 and back cover 40 are relatively rigid, for example, compared to ordinary notebook or multipurpose paper. Referring to FIG. 3, by “rigid,” we mean that the pages 42, front cover 38 and back cover 40, each have a stiffness such that their end 43 will not bend over an angle θ from horizontal that is more than about 20 degrees under their own weight when cantilevered at an opposite end 44. In some embodiments, pages 42 and/or front and back covers 38, 40 will not perceivably bend under their own weight when cantilevered at end 44. The pages 42, front cover 38 and back cover 40 may also have a resilience such that when bent about 20 degrees or less, they spring back toward their original shape. The stiffness and resilience of the pages 42, front cover 38 and back cover 40 can provide protection for photographs affixed thereto and can increase the life of the customized board book 12.

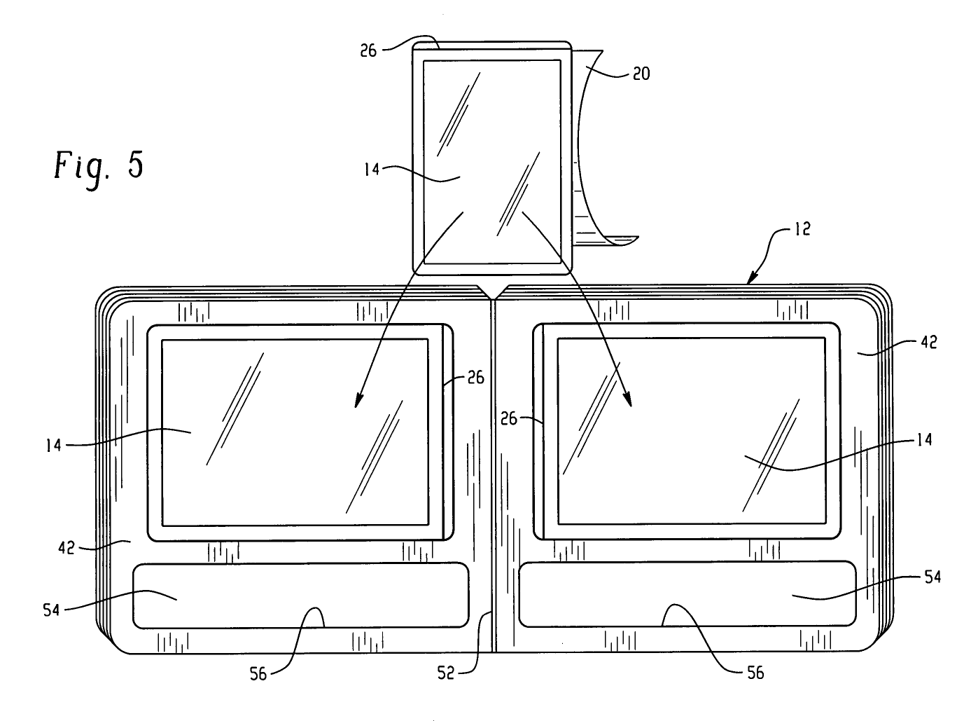

Referring to FIG. 4, page 42 is a laminate formed of a base layer 46 and outer layers 48 and 50 located at opposite sides of the base layer 46. In some embodiments, front and back cover 38, 40 are also laminates. Outer layers 48 and 50 can include a pigment to provide permanently colored surfaces (e.g., red, yellow, blue and/or combinations thereof) and/or designs including text for the pages. For example, the title “MY VACATION BOARD BOOK” shown in FIG. 2 is permanently displayed on the front cover 38. In some cases, opposite sides of a single page 42 may include differing colors. The colors of the pages 42 may be selected to correspond to a pre-selected theme.

Any suitable materials can be selected to form the pages 42 (and front and back cover 48 and 50) including cardboard, plastics, etc. Preferably, the pages 42 are formed of a relatively durable material to inhibit their tearing due to ordinary handling by a child and outer layers 48 and 50 are bonded to base layer 46 to inhibit separation therefrom. In some embodiments, the base layer 46 is formed of die cut cardboard having a thickness of between about ⅛ inch and 1/16 inch and outer layers 48 and 50 are formed of a thin (e.g., less than about 1/16 inch) layer of plastic. In an alternative embodiment, pages 42 may not be a laminate and may be formed of a single layer of, for example, whiteboard. The pages 42 can have a width W of about 7.5 inches and a height H of about 7.5 inches, e.g., to accommodate 4″×6″ photographs, or the pages 42 can have a width W of about 6.5 inches and a height H of about 6.5 inches, e.g., to accommodate 3″×5″ photographs (FIG. 2), as examples.

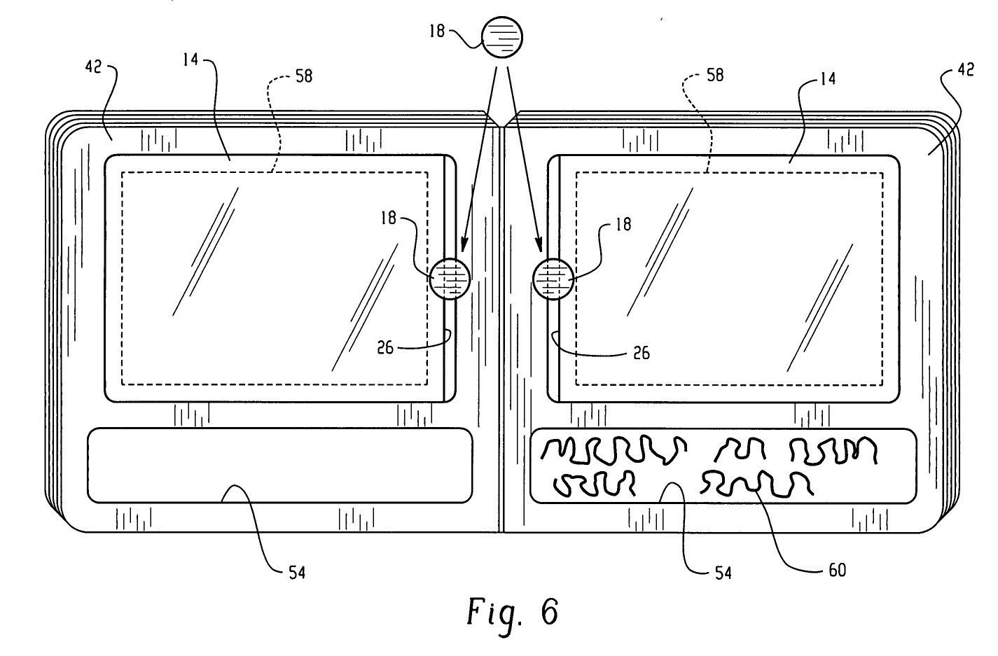

Referring now to FIG. 5, once package 24 has been opened and the items removed from pouch 28, the board book 12 can be customized to create a book format record. In one example, adhesive-backed picture pockets 14 are removed from backing sheet 20 and adhered to pages 42 at user-determined locations. Depending on the number of pages 42, kit 10 may include enough picture pockets 14 for placement of a picture pocket on each side of each page and, in some instances, on front cover 38. Alternatively, there may be less or more picture pockets. In some instances, there may be between about one and 20 picture pockets 14, such as about ten picture pockets included in kit 10.

As can be seen from FIG. 5, the openings 26 of picture pockets 14 face each other and are disposed on opposite side of binding 52. Picture pockets 14 are placed above marking regions 54 that are bounded by a permanently marked border 56. The size of marking regions 54 may be selected such that the picture pocket 14 can be placed on the page 42 without obstructing the marking region, if desired. The marking region 54 may further be filled with a color, such as white, that is different from the color of the rest of the page 42. In some embodiments, marking region 54 may have a surface texture, such as a matte surface, that facilitates marking thereon. In some embodiments, a strip of material, such as an adhesive-backed strip that can be located on the page by the user, may form marking region 54. Material forming the marking region 54 may be selected based on the type of writing instrument 22 included in the kit 10 so that markings can be made using the writing instrument with relative ease. In some instances, there may not be a bordered marking region 54 on the page 42.

Referring to FIG. 6, photographs 58 (shown in phantom) can be located within the picture pockets 14 by inserting (as by sliding) the photographs through openings 26 either prior to or after affixing the picture pockets to pages 42. In some embodiments, the picture pockets 14 are sized to receive certain standard size photographs such as 4″×6″, 3″×5″, etc. and are formed of a transparent material that will not harm the photographs 58 over time. In some embodiments, the picture pockets 14 may also include color and/or designs. Once the photographs 58 are in the desired locations, closures 18 may be adhered to the picture pockets 14 at openings 26 to secure the photographs therein. The child or adult may write text 60 using writing instrument 22 within the marking regions 54 (or anywhere else on the page 42). The text 60 can tell a story or record an event associated with the photograph 58 on the respective page 42.

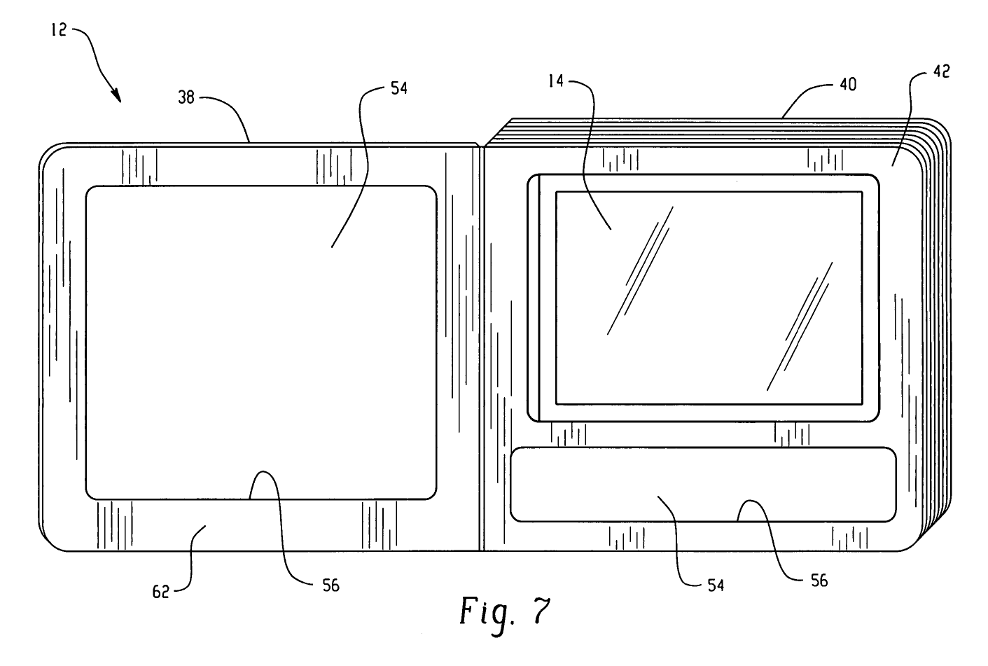

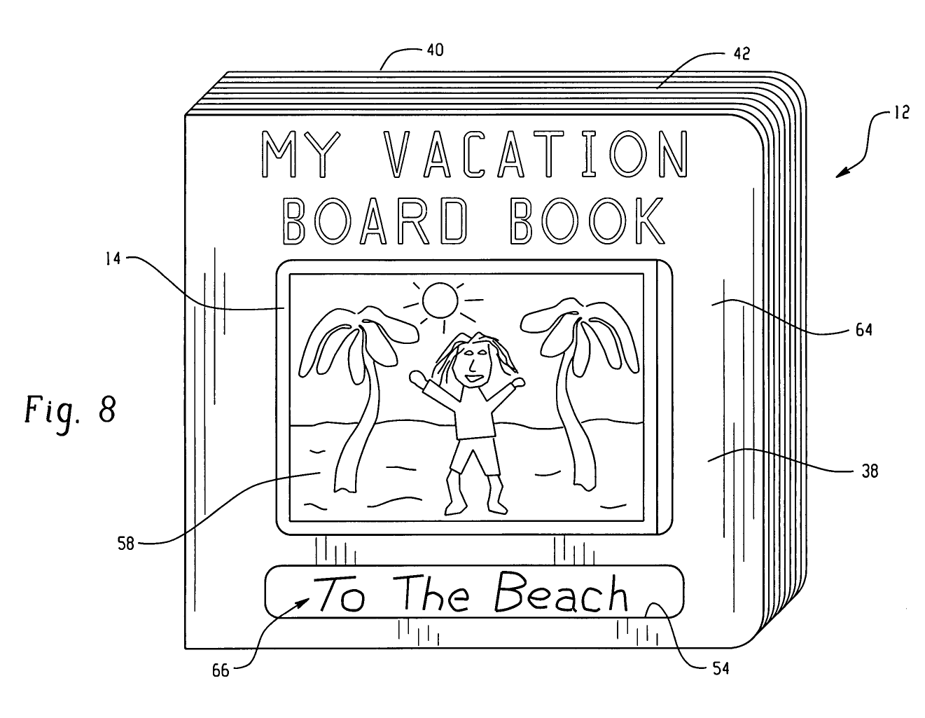

Referring to FIGS. 7 and 8, board book 12 can include pages 42, front cover 38 and/or back cover 40 having any desired layout and any desired permanent designs. For example, FIG. 7 shows a relatively large (e.g., compared to that of page 42) marking region 54 disposed on an inside surface 62 of front cover 38. This marking region 54 can be used, for example, to include a child's name as the author or main character, to record the date and location of the recorded event, and/or to include a preface or introduction to the record or story. FIG. 8 shows outside surface 64 front cover 38 with picture pocket 14, photograph 58 and marking region 54. The marking region 54 on the front cover 38 can be used to create a subtitle 66 for the recorded event.

While the title “MY VACATION BOARD BOOK” is a title example referred to above tending to create a vacation-oriented theme for the recorded event or story, examples of other titles include “MY BOARD BOOK,” “MY FAMILY BOARD BOOK,” “MY ADVENTURE BOARD BOOK,” “MY BIRTHDAY BOARD BOOK,” “MY COUNTING BOARD BOOK,” “MY ABCs BOARD BOOK,” “MY SPORTS BOARD BOOK,” “MY PET BOARD BOOK,” “MY HOLIDAY BOARD BOOK” and “MY ZOO BOARD BOOK.”

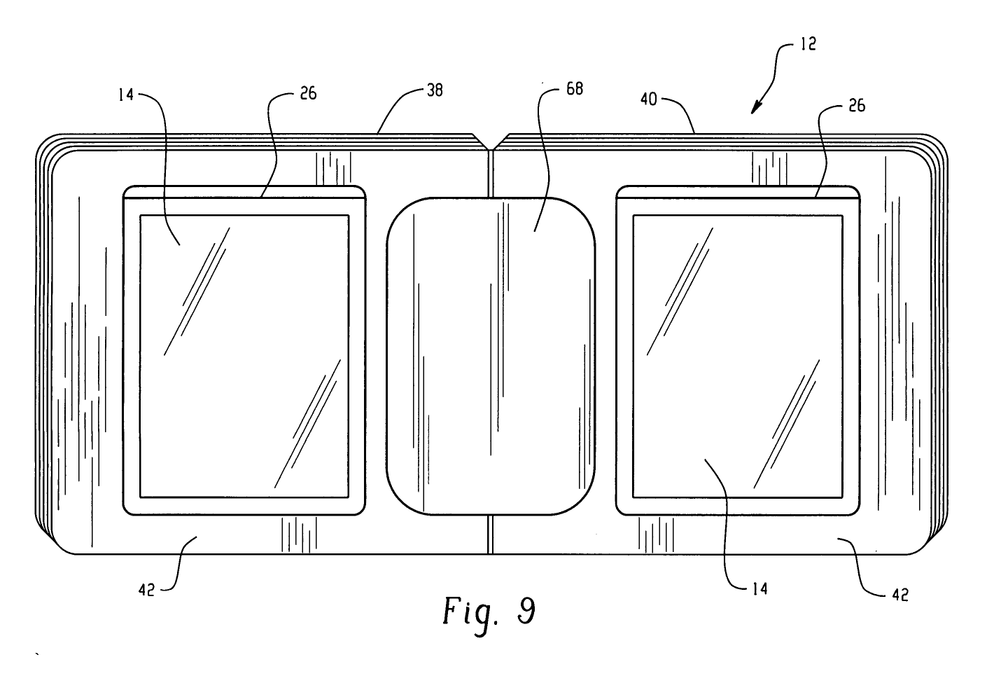

Kit 10 can be specifically designed for use and assembly by young children, for example, between ages one and five. The board book 12 and other items included in kit 10 can be selected to allow for relatively quick assembly of the board book such as within about 40 minutes or less, such as between about 20 and 40 minutes. The number of pages 42 can be less than ten, such as five or less, such as four with each page having sides. The pages 42, front cover 38 and rear cover 40 can be bound by any suitable method including adhesives that are child suitable. Referring to FIG. 9, in some embodiments, pages 42 may be bound using adhesive-backed film 68. This can enable a child or adult to assemble a board book 12 from separate pages 42 and/or covers 38 and 40. Components of kit 10 can also be selected to keep the weight of the completed board book below a pre-selected weight, such as less than about two pounds, such as about one pound or less to facilitate the completed board book's portability, particularly when being transported by a young child.

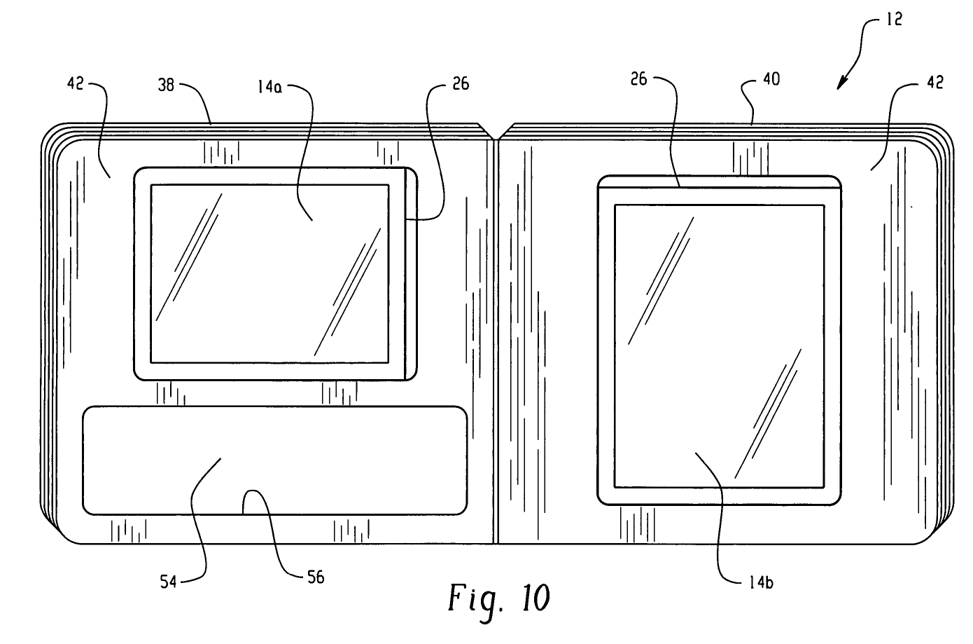

A number of detailed embodiments have been described. Nevertheless, it will be understood that various modifications may be made. For example, kit 10 may include other types of components for affixing the photographs 58 to the pages 42 such as photo corners. Referring to FIG. 10, different size picture pockets 14a and 14b may be included in the same kit 10. As noted above, the board book 12 may include permanent, pre-applied designs on pages 42 and/or front and back cover 38, 40. For example, a board book 12 entitled MY VACATION BOARD BOOK may include permanent, pre-applied drawings such as a beach, chairs, sea gulls, shells, surfboards or any other graphic associated with a vacation. In some embodiments, instructions for assembling the board book 12 are permanently printed on the board book, for example, on an outer surface of rear cover 40. Accordingly, other embodiments are within the scope of the following claims.

What is claimed is:

1. A kit for enabling a child to produce a book format record including customized text and photographs of a particular event experienced by the child, the kit comprising:
a board book including a plurality of bound, substantially rigid pages; and
a plurality of picture pockets, each picture pocket including an affixing portion for enabling the picture pocket to be affixed to a page of the board book, the picture pockets including a front portion adapted to permit picture viewing;
wherein the board book and the picture pockets are packaged together for purchase with at least some of the picture pockets unattached to the board book so that picture pockets can be attached to the pages at child selected locations after the kit is purchased.

2. The kit of claim 1, wherein the picture pockets include a front and a back, the front and back defining a volume and an opening to the volume sized to receive the photograph.

3. The kit of claim 2 further comprising closures configured to close the openings of the picture pockets.

4. The kit of claim 3, wherein the closures are adhesive-backed.

5. The kit of claim 1, wherein the affixing portion includes adhesive.

6. The kit of claim 1 further comprising a writing instrument for use in marking pages of the board book.

7. The kit of claim 1 further comprising graphics configured to be affixed to the pages, the graphics including illustrations or text.

8. The kit of claim 1, wherein pages of the board book comprise multiple laminated layers.

9. The kit of claim 8, wherein the laminated layers comprise a base layer of cardboard.

10. The kit of claim 1, wherein the pages comprise whiteboard.

11. The kit of claim 1 further comprising a front cover and a back cover, the pages being bound together between the front and back covers.

12. The kit of claim 1 packaged in one of a bag, a box, shrink wrap or blister packaging.

13. The kit of claim 1, wherein pages of the board book include a marking region, the pages and picture pockets being sized to allow for placement of the picture pocket on the page without obstructing the marking region.

14. A method of making a kit for use in creating a book format record including customized text and photographs of a particular event experienced by a child, the method comprising:
providing a board book including a plurality of bound, substantially rigid pages;
providing a plurality of picture pockets, each picture pocket including an affixing portion for enabling the picture pocket to be affixed to a page of the board book, the picture pockets including a front portion adapted to permit picture viewing; and
packaging the board book and the picture pockets together for purchase with at least some of the picture pockets unattached to the board book so that picture pockets can be attached to the pages at child selected locations after the kit is purchased.

15. The method of claim 14, wherein the step of packaging includes placing the board book and picture pockets in one of a box, a bag or a blister package.

16. The method of claim 14 further comprising
providing a writing instrument for writing on the pages; and
packaging the writing instrument with the board book and picture pockets.

17. The method of claim 14 further comprising
providing closures for use in closing openings of the picture pockets; and
packaging the closures with the board book and picture pockets.

18. The method of claim 17 further comprising
providing adhesive-backed graphics; and
packaging the graphics with the board book and picture pockets.

19. The method of claim 14 comprising
providing multiple board books including a plurality of bound, substantially rigid pages; and
packaging the board books and plurality of picture pockets together for purchase with the picture pockets unattached to the board books so that the picture pockets can be attached to the board book pages at child selected locations after the kit is purchased.

20. A kit for enabling a child to produce a book format record including customized text and photographs of a particular event experienced by the child, the kit comprising:
a board book including a plurality of bound, substantially rigid pages disposed between a front cover and a back cover, the pages, front cover and back cover each in the form of a laminate where the front cover includes a title permanently applied to an outer surface of the front cover, the title tending to create a first theme;
adhesive-backed picture pockets carried by a backing sheet, the backing sheet configured to allow the picture pockets to be removed therefrom to be affixed to a page of the board book, the picture pockets including a front portion adapted to permit picture viewing; and
a writing instrument for use in customizing the board book;
wherein the board book, the picture pockets and the writing instrument are packaged together for purchase with at least some of the picture pockets unattached to the board book so that picture pockets can be attached to the pages at child selected locations after the kit is purchased.

21. The kit of claim 20 further comprising a second board book including a plurality of bound, substantially rigid pages disposed between a front cover and a back cover, the front cover of the second board book including a second title permanently applied to an outer surface of the front cover, the second title tending to create a second theme different from the first theme.

22. The kit of claim 20, wherein the board book is packaged to permit a user to view the title of the board book through packaging.
